(19) United States
(12) Patent Application Publication
(10) Pub. No.: US 2013/0002870 A1
(43) Pub. Date: Jan. 3, 2013

(54) Method for the Output of Information

(75) Inventors: Stephan CIELER, Frankfurt (DE); Katrin LÜBBERT, Darmstadt (DE); Guido Meier-Arendt, Langen (DE); Alexander Niemeyer, Babenhausen (DE); Carmen Solterbeck, Frankfurt (DE)

(73) Assignee: Continental Automotive GmbH, Hannover (DE)

(21) Appl. No.: 13/336,645

(22) Filed: Dec. 23, 2011

(30) Foreign Application Priority Data
Dec. 23, 2010 (DE) 10 2010 055 795.1

(51) Int. Cl. G05B 19/00; H04N 7/18

(52) U.S. Cl. 348/148; 340/5.52; 340/5.3; 348/E07.085

(57) ABSTRACT

A method for the output of information by an output unit in the passenger compartment of a motor vehicle on the basis of capturable personal data. Activation of an approach module is followed by initiation of person recognition, in which personal data from a person who is outside of the motor vehicle are captured by an ambient sensor system and are compared with stored personal data. If the captured personal data match stored personal data then output of information relating to the person is initiated by the output unit.

### BACKGROUND OF THE INVENTION

1. Field of the Invention

The invention relates to a method for the output of information by an output unit in a passenger compartment of a motor vehicle based at least in part on capturable personal data.

2. Description of the Related Art

DE 698 36 846 T2 discloses an appliance fitted in a motor vehicle that has an output unit in the form of a display or a loudspeaker. A memory stores personal data for a number of people.

This personal data may be called by the driver of the motor vehicle for the purpose of communicating with a person whose personal data is stored.

For communication purposes, a camera can take photographs of the interior and exterior of the motor vehicle.

The display can be used to present images of the called person and of the photographs taken by the camera.

### SUMMARY OF THE INVENTION

It is an object of one embodiment of the invention to provide a method of the type cited at the outset that allows personal information to be output by an output unit.

The invention achieves this object by virtue of activation of an approach module being followed by initiation of person recognition, in which personal data from a person who is outside of the motor vehicle are captured by an ambient sensor system and are compared with stored personal data, and if the captured personal data match stored personal data then output of information relating to the person is initiated by the output unit. In one embodiment, the approach module is embodied as part of the election control module of the vehicle.

This method allows the captured personal data to be taken as a basis for output of information about the recognized person by the output unit. This information is correlated to the person and is stored in a memory in the motor vehicle. When the person is recognized, the output unit can greet the person.

If the approach module is unable to recognize the person who is outside of the motor vehicle, then, if the captured personal data does not match the stored personal data then output of information relating to the lack of knowledge about the person and/or to nonpersonal information is initiated by the output unit.

To detect the people who are outside of the motor vehicle from their personal data, the captured personal data can be captured by approach sensors and/or by camera systems and/or by a transmission unit.

The approach sensors detect the approach of a person to the motor vehicle.

The camera system records the approaching person, and the recorded images are compared with images or people which are stored in a memory in the motor vehicle.

If it is possible to establish a match between the recorded images and stored image data then information is output.

This may be the stored images, the images recorded by the camera system, text outputs, or voice outputs.

The transmission unit may be a transmission chip in a key of the motor vehicle in which data is stored as being associated with a particular person in the memory of the motor vehicle and, in the event of an approach to the motor vehicle, communicates with an appropriate reception unit in the motor vehicle and initiates a comparison with the stored personal data.

The approach sensors are preferably ultrasonic sensors.

Depending on the type of output unit, the output of information by the output unit may be image information and/or audio information and/or lighting activation.

The lighting activation allows interior lighting to be switched on and/or the headlamps to be switched on.

The image information can be output as an image presentation but also as a text output.

Audio information is output preferably as a voice output.

Alternatively, it is possible for the output to be an audio sequence associated with the information that is to be output.

The image information is preferably output on a display which may be the display of a freely programmable display instrument in the motor vehicle.

In the event of the lack of knowledge about the person approaching the motor vehicle, the audio information and/or the image information may be a piece of warning and/or alarm information.

This produces a theft or vandalism warning.

If the image information that is output on the display is the image of the person who has approached the motor vehicle that are recorded by the camera system then the image information can be stored to be used for later identification of the thieves or of the people damaging the motor vehicle.

The information to be output can be output temporarily preferably only for a particular time.

If the image information is output until new information that is to be output by the output unit is initiated as a screen saver then the effect of a black interface with a cheap appearance in the motor vehicle is avoided.

Alternatively, it is possible for a situation in which there is no information initiated by the approach module to prompt the display to present other display contents, such as advertising or information about the motor vehicle, about the current location of the motor vehicle, or the time of day.

To avoid confusing information being provided as a result of a quickly changing environment for the motor vehicle, the approach module is preferably activated by the presence of a standstill signal from the motor vehicle.

The personal data that is stored in the memory unit of the motor vehicle may be able to be input into a memory using an input unit and stored in the memory for the person recognition.

Alternatively, it is possible for the personal data to be created externally, e.g. using a personal computer, and then transferred to the memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is shown in the drawing and is described in more detail below.

FIG. 1 is a flowchart for a method for the output of information.

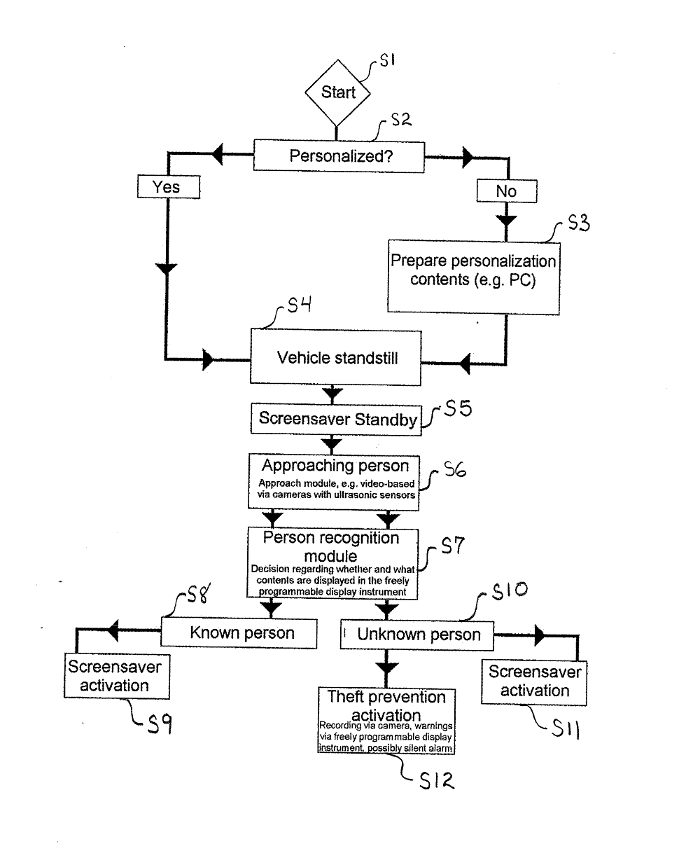

### DETAILED DESCRIPTION OF THE PRESENTLY PREFERRED EMBODIMENTS

When an information system has started 51, an input unit can be used to input personal data into a memory in the motor vehicle S2.

When the personal data has been input S3 or if personal data is not input, the information system initially remains inactive if the motor vehicle is traveling.

When the vehicle comes to a standstill S4, a screen saver S5 on a display in the passenger compartment of the motor vehicle is first of switched to standby.

In addition, the approach module is activated S6, said approach module having a camera system that at least recognizes when people approach the vehicle.

These people are recorded by the camera system and the resultant personal data is supplied to a person recognition module S7.

The person recognition module performs a check to determine whether the captured personal data match personal data stored in a memory and therefore the person approaching the motor vehicle is recognized.

If the person recognition module recognizes that the person approaching the motor vehicle is a known person S8 then the screen saver for the display is activated S9, said screensaver containing an output of information which relates to the person who is approaching the motor vehicle.

By way of example, this may be a greeting relating to the person that calls the person by name and which is presented as a text by the screensaver and/or is output as a voice output.

If the person recognition module recognizes the person who is approaching the motor vehicle not as a known person but rather as an unknown person S10, since no corresponding personal data is stored, then the screensaver for the display is activated with an output of the information that this person is unknown S11. In addition, this information may also include warning and alarm information.

The personal data recorded by the camera system is image data stored at least for a particular time.

Should the person who is approaching the motor vehicle have caused damage to the motor vehicle or even have stolen the motor vehicle then the stored image data can later be used for ascertaining and identifying this person S12.

As soon as the motor vehicle resumes travel mode, the screensaver on the display is switched to standby again.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method to output of information by an output unit in a passenger compartment of a motor vehicle based at least in part on capturable personal data, comprising:
activating an approach module;
initiating person recognition in response to the approach module activation in which personal data of a person outside of the motor vehicle is captured by an ambient sensor system;
comparing the captured data with stored personal data; and
outputting information relating to the person is initiated by the output unit if the captured personal data match the stored personal data.

2. The method as claimed in claim 1, further comprising:
outputting of information relating to at lest one of a lack of knowledge about the person and non-personal information is initiated by the output unit if the captured personal data does not match the stored personal data.

3. The method as claimed in claim 1, wherein the captured personal data is captured by at least one of approach sensors, a camera system and a transmission unit.

4. The method as claimed in claim 2, wherein the output of information by the output unit is at least one of image information, audio information, and lighting activation.

5. The method as claimed in claim 4, wherein the audio information is output as a voice output.

6. The method as claimed in claim 4, wherein the image information is output on a display.

7. The method as claimed in claim 4, wherein if there is a lack of knowledge about the person approaching the motor vehicle then at least one of the audio information and the image information is at least one of a piece of warning and alarm information.

8. The method as claimed in claim 6, wherein the image information that is output on the display is an image of the person that has approached the motor vehicle and recorded by the camera system.

9. The method as claimed in claim 1, wherein the approach module is activated by a standstill signal from the motor vehicle.

10. The method as claimed in claim 1, further comprising:
inputting personal data into a memory via an input unit; and
storing the input in the memory for the person recognition.

11. The method as claimed in claim 2, wherein the captured personal data is captured by at least one of approach sensors, a camera system and a transmission unit.
